(19) United States
(12) Patent Application Publication
(10) Pub. No.: US 2010/0251957 A1
(43) Pub. Date: Oct. 7, 2010

(54) MAKING PYLONS AND APPARATUS FOR HANDLING

(75) Inventor: Andy Beattie, Swift Current (CA)

Correspondence Address: STANDLEY LAW GROUP LLP, 6300 Riverside Drive, Dublin, OH, 43017, US

(73) Assignee: ASB Manufacturing Inc., Swift Current, SK (CA)

(21) Appl. No.: 12/531,392

(22) PCT Filed: Feb. 26, 2008
(86) PCT No.: PCT/CA2008/000401

§ 371 Date: Jun. 11, 2010

(30) Foreign Application Priority Data
Mar. 15, 2007 (CA) 2,583,133

(51) Int. Cl. B25J 1/04; B25J 15/00; B65G 57/30; B65G 59/10; B65G 59/06; E01F 9/014

(52) U.S. Cl. 116/63 P; 414/788.2; 294/97

(57) ABSTRACT

A pylon handling system includes stackable pylons with a top defining a horizontal engagement hole with a rigid rim, and a pylon handling apparatus. The pylons are configured to be stacked with a lower pylon nested inside an adjacent upper pylon such that a separation space is present between the rigid rims of the upper and lower pylons. The pylon handling apparatus is configured such that an operator holding the handle can insert the pylon engagement mechanism through the engagement hole in a first pylon to engage the first pylon on the pylon handling apparatus, and then insert the pylon engagement mechanism through the engagement hole in a second pylon to engage the second pylon on the pylon handling apparatus under the first pylon. The operator can manipulate the trigger to release the second pylon from the pylon engagement mechanism while retaining the first pylon on the pylon handling apparatus.

The invention is in the field of marking pylons or cones such as are used for traffic warning, and are also used as markers for various sports activities on playing fields or ice surfaces.

### BACKGROUND

Lightweight warning markers in the form of hollow, typically plastic, pylons are sometimes carried in vehicles in case of emergency. When the vehicle is disabled on the side of the road, such as by an accident or malfunction, the pylons are set out upstream of the traffic to direct traffic around the vehicle. Similarly in sports it is often desirable to use portable markers to outline the boundaries for a game, or to create a pattern on a field or ice surface for coaching drills.

These pylons are commonly conical in shape such that same may be economically manufactured and stacked into a relatively compact volume for storage in a vehicle, storage room, or the like when not in use. The height of the cones or pylons will depend somewhat on the uses to which they will be put, but generally it is desired to keep them as short as possible to improve stability. As the height of a pylon increases, the stability thereof decreases, and higher pylons are more subject to falling over.

When setting out the pylons the operator carries the stack of pylons to the desired location, and then removes the top or bottom pylon from the stack, bends to place it in position, then moves on to the next pylon location and repeats the process until the desired pylon configuration is achieved. When the purpose for the pylons has been achieved, the operator reverses the process, bending to retrieve each pylon and stacking the retrieved pylon with those previously retrieved until all pylons are again stacked.

### SUMMARY OF THE INVENTION

It is an object of the present invention to provide a marking pylon and a pylon handling apparatus that overcomes problems in the prior art.

In a first embodiment the invention provides a pylon comprising a top plate defining a substantially horizontally oriented engagement hole with a substantially rigid rim, walls sloping outward and downward from outer edges of the top plate to a base, and a plurality of spacer bumps extending inward from inner surfaces of the walls. The pylon is configured such that a plurality of pylons can be stacked with a lower pylon nested inside an adjacent upper pylon such that inner ends of the spacer bumps on the upper pylon bear against an outer surface of the walls of the lower pylon, and such that a separation space is present between the rigid rims of the upper and lower pylons.

In a second embodiment the invention provides a pylon handling system comprising a plurality of pylons and a pylon handling apparatus. Each pylon comprises a top plate defining a substantially horizontally oriented engagement hole with a substantially rigid rim, and walls sloping outward and downward from outer edges of the top plate to a base. The pylons are configured such that a plurality of pylons can be stacked with a lower pylon nested inside an adjacent upper pylon and such that a separation space is present between the rigid rims of the upper and lower pylons. The pylon handling apparatus comprises a hollow shaft with a handle at an upper end thereof, a pylon engagement mechanism at an opposite lower end of the hollow shaft, and a trigger adjacent to the handle and connected through the hollow shaft to the engagement mechanism. The pylon handling apparatus is configured such that an operator holding the handle can insert the pylon engagement mechanism through the engagement hole in a first pylon past the rigid rim thereof to engage the first pylon on the pylon handling apparatus, and such that an operator holding the handle can then insert the pylon engagement mechanism through the engagement hole in a second pylon past the rigid rim thereof to engage the second pylon on the pylon handling apparatus under the first pylon. The operator can manipulate the trigger to release the second pylon from the pylon engagement mechanism while retaining the first pylon on the pylon handling apparatus.

A first pylon is picked up, and then to pick up the second pylon, the first pylon is placed over the second pylon and the engagement mechanism is pushed through the engagement hole in the top of the second pylon, and the first pylon moves upward along the shaft. The engagement mechanism then engages the rim of the engagement hole in the second pylon, and the first pylon rests on the second pylon which is supported by the engagement mechanism. Subsequent pylons are picked up in a like manner, with prior pylons moving up the shaft. The pylons are hollow and commonly conical with a truncated top, and fit into each other in a stacked or nested manner, with a space between the top of any pylon and the tops of the pylons above and below it.

In one embodiment the engagement mechanism is operative to exert a downward force on the bottom pylon to push it downward so that any friction between the pylon to be released and the next pylon above can be overcome and the pylon can be released. As the bottom pylon is being pushed downward, the pylon above it is supported by the engagement mechanism and thus prevented from moving downward as the bottom pylon is released. The engagement mechanism is configured so that when the bottom pylon is released, the engagement mechanism engages the rim of the next pylon, which can then also be pushed downward while the pylons above it are maintained on the shaft.

The marking pylons can be made from relatively rigid plastic (hard pylons) or from more flexible resilient plastic (soft pylons) such as are sometimes used to prevent damage from being driven over or the like. Where a soft pylon is being used with the pylon handling apparatus, a rigid plastic ring is secured to the top of the soft pylon to provide a rigid engagement hole.

The pylon handling apparatus of the invention can be loaded with pylons to form a relatively compact apparatus that can be carried in a vehicle for emergency traffic warning if required. Similarly the apparatus will be useful in sports or any field of endeavor where marking pylons are used.

### DESCRIPTION OF THE DRAWINGS

While the invention is claimed in the concluding portions hereof, preferred embodiments are provided in the accompanying detailed description which may be best understood in conjunction with the accompanying diagrams, where like parts in each diagram are labeled with like numbers and where:

FIG. 1 is a perspective cut-away view of an embodiment of a pylon handling apparatus of the present invention and a pylon suitable for use with the embodiment;

FIG. 2 is a perspective exploded view of the pylon handling apparatus of FIG. 1;

FIG. 3 is a perspective exploded view of the engagement mechanism of the pylon handling apparatus of FIG. 1;

FIG. 4 is a top view of a stack of pylons suitable for use with the embodiment of FIG. 1;

FIG. 5 is a schematic sectional side view along line 5-5 in FIG. 4 showing two pylons nested in a stacked relationship;

FIGS. 6-10 schematically illustrate the operation of the engagement mechanism of the embodiment of FIG. 1 in picking up and releasing pylons

FIG. 11 is a schematic sectional side view of the pylon handling apparatus of FIG. 1 engaging a plurality of pylons.

### DETAILED DESCRIPTION OF THE ILLUSTRATED EMBODIMENTS

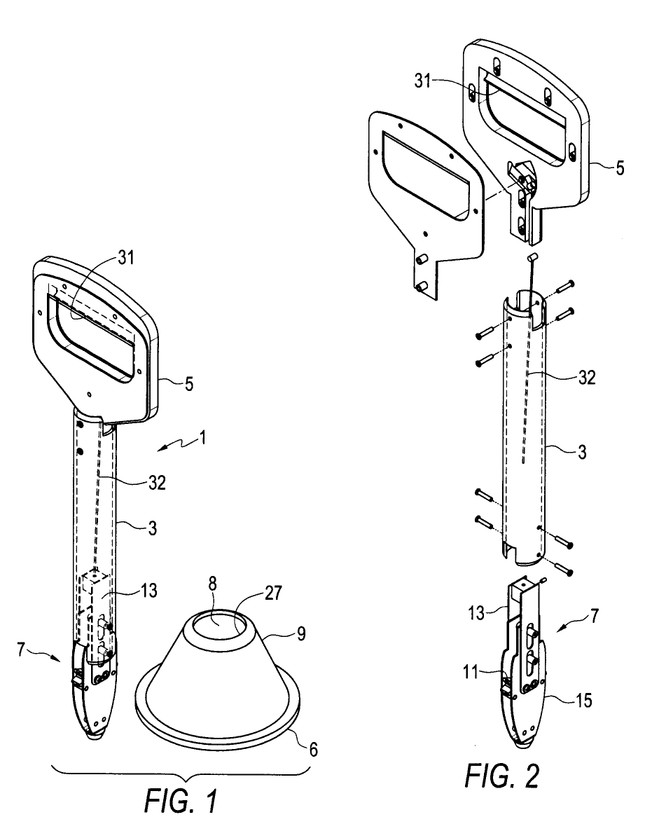

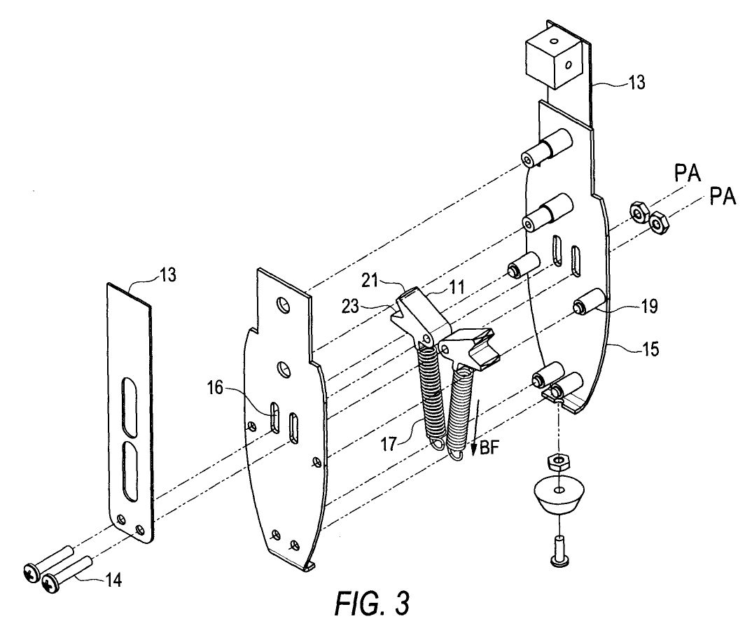

FIGS. 1-3 illustrate an embodiment of a pylon handling apparatus 1 of the present invention comprising a hollow shaft 3 with a handle 5 at an upper end thereof and a pylon engagement mechanism 7 at the opposite lower end thereof. The apparatus 1 is designed to pick up and drop stacking pylons that include a horizontally oriented engagement hole 8 in the truncated tops thereof, substantially as illustrated by the pylon 9 in FIG. 1. It is contemplated that pyramidical or like shapes other than the illustrated circular conical pylon could also be used. The pylons 9 each comprise a top plate provided by a rigid plastic ring 12 defining the horizontally oriented engagement hole 8 with a rigid rim 27. Walls slope outward and downward from outer edges of the ring 12 to a base. In the illustrated embodiment the base is provided by a base ring 6 with a substantially flat bottom surface to facilitate placing the pylon 9 on a surface.

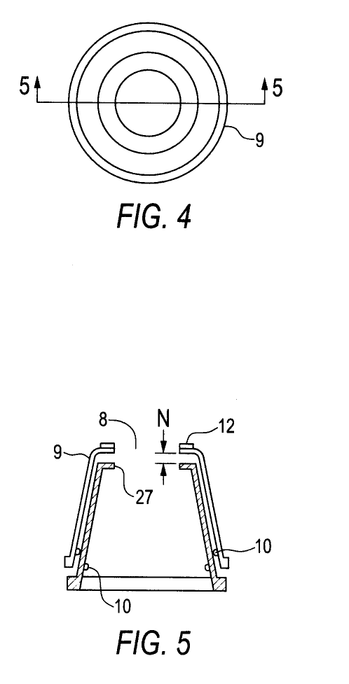

The pylons 9 should be hollow and stackable such that they can nest one inside the other with a space N between the top of any pylon and the tops of the pylons above and below it substantially as illustrated in FIGS. 4 and 5. Typically it will be required to provide spacers to ensure that the space N is provided. In the embodiment of FIG. 5, spacer bumps 10 extend inward from inner surfaces of the pylon walls, and are spaced evenly around the inside of the pylon 9 somewhat above the bottom thereof to ensure the space N is provided. Thus each pylon 9 is configured such that a plurality of pylons 9 can be stacked with a lower pylon nested inside an adjacent upper pylon such that inner ends of the spacer bumps 10 on the upper pylon bear against an outer surface of the walls of the lower pylon, and such that the separation space N is present between the rigid rims 27 of the rings 12 of the upper and lower pylons.

The spacer bumps 10 also prevent the walls of one pylon from frictionally jamming into another pylon and making them difficult to separate. The marking pylons 9 can be hard pylons made from relatively rigid material, typically plastic, or soft pylons made from more flexible resilient plastic. Where a soft pylon is being used with the pylon handling apparatus 1, a rigid plastic ring 12, as illustrated in FIG. 5, can be secured to the top of the soft pylon to provide a rigid rim 27 around the engagement hole 8.

The pylon handling apparatus 1 includes a trigger 31 adjacent to the handle 5 that is connected through the hollow shaft 3 to the pylon engagement mechanism 7. The pylon handling apparatus 1 is configured such that an operator holding the handle 5 can insert the pylon engagement mechanism 7 through the engagement hole 8 in a first pylon past the rigid rim 27 thereof to engage the first pylon on the pylon handling apparatus 1, and such that an operator holding the handle 5 can then insert the pylon engagement mechanism 7 through the engagement hole 8 in a second pylon past the rigid rim 27 thereof to engage the second pylon on the pylon handling apparatus 1 under the first pylon. The operator can manipulate the trigger 31 to release the second pylon from the pylon engagement mechanism 7 while retaining the first pylon on the pylon handling apparatus 1.

Similarly as illustrated in FIG. 11, with the first and second pylons 9A, 9B, engaged on the pylon engagement mechanism 7 of the pylon handling apparatus 1, the operator holding the handle 5 can insert the pylon engagement mechanism 7 through the engagement hole 8 in a third pylon 9C past the rigid rim 27 thereof to engage the third pylon 9C on the pylon handling apparatus 1 under the second pylon 9B. The operator can manipulate the trigger to release the third pylon 9C from the pylon engagement mechanism 7 while retaining the first and second pylons 9A, 9B on the pylon handling apparatus 1.

The operator can thus place a stack of pylons on the apparatus and drop same one at a time in desired locations. When the pylons have served their purpose the operator can return and again pick them up by stacking them on the apparatus as described above.

In the illustrated pylon handling apparatus 1 the pylon engagement mechanism 7 at the lower end the hollow shaft 3 comprises a pair of opposing pivot arms 11 pivotally mounted at inner ends thereof to trigger plates 13 about pivot axes PA oriented substantially perpendicular to the shaft 3. The trigger plates 13 are slidably mounted outside a corresponding pair of side plates 15 attached to the bottom end of the shaft 3. The trigger plates 13 can move upward relative to the side plates 15 as the fasteners 14 slide in slots 16.

Springs 17 are attached to the pivot arms 11 and to lower portions of the side plates 15 and exert a bias force BF downward on the pivot arms 11 such that in a resting position the pivot arms 11 are forced by the bias force BF against stops 19 that are fixed to the side plates 15. The springs 17 are attached to the pivot arms 11 between the stops and the pivot axes PA such that in addition to exerting a downward bias force BF on the pivot arms 11, the downward bias force BF is also exerted on the trigger plates 13 so that the trigger plates 13 are urged downward relative to the side plates 15.

Upper and lower lugs 21, 23 on outer ends of each pivot arm 11 define recesses 25 that are configured to engage the rim 27 of the engagement hole 8. The recesses 25 engage opposed portions of the rigid rim 27 such that the pylons can be supported on the pivot arms 11. The side plates 15 have a width slightly less than the diameter of the engagement hole 8 and in the resting position the lower lugs 23 extend outward from the edges of the side plates 15 and past the rim 27 of the engagement hole 8 on each side of the engagement mechanism 7.

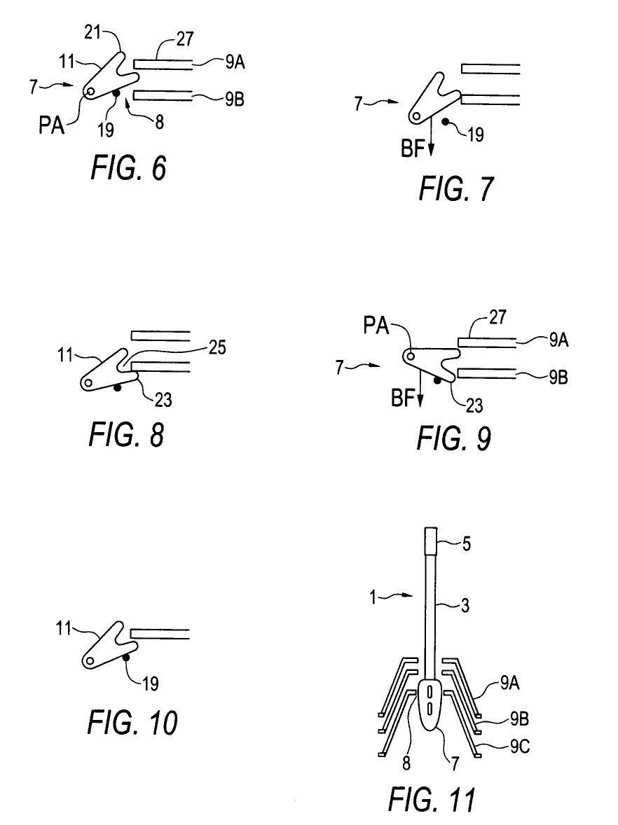

Thus when the side plates 15 are pushed downward through the engagement hole 8, the bottom lugs 23 extending from opposite sides of the side plates 15 in the resting position contact the rim 27 of the engagement hole 8. FIG. 6 schematically illustrates the operation of the engagement mechanism 7. In FIG. 6 a first pylon 9A is being carried on the engagement mechanism 7, and the engagement mechanism 7 is being pushed into the engagement hole 8 of a second pylon 9B to pick up the second pylon 9B.

As the bottom lugs 23 contact the rim 27 in FIG. 6, the engagement mechanism 7 on the end of the shaft is pushed downward and the pivot arms 11 move upward off the stop 19 and inward against the bias force BF, and so pass through the engagement hole 8 as shown in FIG. 7. When the bottom lugs 23 have moved through the engagement hole 8, the bias force BF moves the pivot arms 11 downward and outward and the rim 27 of the engagement hole 8 is located above the bottom lug 23 and below the top lug 21 in the recess 25 as shown in FIG. 8.

As illustrated in FIGS. 6-8 a first pylon 9A engaged in the recess 25 can be placed over a second pylon 9B and the engagement mechanism 7 pushed through the engagement hole 8 on the second pylon 9B such that the rim of the engagement hole 8 of the second pylon 9B is engaged in the recess 25 and the first pylon 9A is stacked on the second pylon 9B. Subsequent pylons are picked up in a like manner, with prior pylons moving up the shaft.

When it is desired to drop a pylon, a trigger 31 at the upper end of the shaft 3 is operated to move rod 32, and the trigger plates 13 connected to the rod 32, upward relative to the side plates 15. Thus the inner ends of the pivot arms 11, pivotally attached to the trigger plate 13 at pivot axes PA, move upward and the pivot arms 11 remain forced against the stops 19 by the bias force BF and lugs 21, 23 move relatively downward. As the bottom lugs 23 move down, the pivotal connection also causes them to move inward such that the rim 27 of the engagement hole of the bottom pylon 9B moves past the ends of the bottom lugs 23 and is released from the engagement mechanism 7, as shown in FIG. 9. The next adjacent pylon 9A above the released pylon 9B rests on the upper lugs 21 of the pivot arms 11. Once the pylon 9A is dropped the trigger is released and the trigger plates and pivot axes PA move downward in response to the bias force BF, and the pivot arms 11 pivot upward such that the upper lugs 21 move upward and inward such that the rim 27 of the next pylon 9A drops past the ends of the upper lugs 21 and rests on the lower lugs 23, again in the recess 25 between the upper and lower lugs. The pylons on the shaft can thus be released one at a time in the same manner.

Thus the pivot arms 11 are configured such that when the pylon engagement mechanism is inserted through the engagement hole 8 in the second pylon 9B the lower lugs 23 on the pivot arms 11 extending from opposite sides of the side plates 15 in the resting position contact the rigid rim 27 of the second pylon 9B and the pivot arms 11 pivot upward and inward against the bias force BF until the lower lugs 23 are below the rigid rim 27, and when the lower lugs 23 are below the rigid rim 27 the pivot arms 11 move down against the stops 19 in response to the bias force BF such that the rigid rim 27 of the second pylon 9B is positioned in the recesses 25 of the pivot arms 11, and such that the upper lugs 21 are located in the separation space between the first and second pylons.

Operating the trigger 31 raises the inner ends of the pivot arms 11 such that the pivot arms 11 pivot about the stops 19 and such that the recess 25 tilts downward and the lower lugs 23 move downward and inward to a location inside the engagement hole 8 of the second pylon 9B such that the second pylon 9B can drop off the pylon engagement mechanism 7, and such that the upper lugs 21 move outward under the rigid rim 27 of the first pylon 9B to prevent downward movement of the first pylon. The upper lugs 21 move downward, and if the second pylon 9B is stuck or adhered to the upper pylon 9A instead of dropping of the apparatus 1 when the trigger is operated, the upper lugs 21 will contact the rigid rim 27 of the second pylon 9B and exert a downward force on the second pylon 9B to push it down and away from the first pylon 9A while retaining the first pylon 9A on the pylon engagement mechanism 7.

Releasing the trigger 31 allows the inner ends of the pivot arms 11 to move down in response to the bias force BF such that the recess 25 tilts upward and the upper lugs 21 move inward to a location inside the engagement hole 8 of the first pylon 9A such that the rigid rim 27 of the first pylon 9A can move into engagement with the recesses 25.

Thus a pylon handling system of the present invention comprises a plurality of suitably configured stackable pylons, and a pylon handling apparatus as generally described above. The system allows the pylons to be stacked on the pylon handling apparatus for compact storage and transport, and then allows an operator to drop the pylons one at a time in desired locations without bending over, and allows the operator to return and pick up the pylons and return them to the stacked position on the pylon handling apparatus again without bending over.

The foregoing is considered as illustrative only of the principles of the invention. Further, since numerous changes and modifications will readily occur to those skilled in the art, it is not desired to limit the invention to the exact construction and operation shown and described. Accordingly, all such suitable changes or modifications in structure or operation that may be resorted to are intended to fall within the scope of the claimed invention.

1. A pylon comprising:
a top plate defining a substantially horizontally oriented engagement hole with a substantially rigid rim;
walls sloping outward and downward from outer edges of the top plate to a base; and
a plurality of spacer bumps extending inward from inner surfaces of the walls;
wherein the pylon is configured such that a plurality of pylons can be stacked with a lower pylon nested inside an adjacent upper pylon such that inner ends of the spacer bumps on the upper pylon bear against an outer surface of the walls of the lower pylon, and such that a separation space is present between the rigid rims of the upper and lower pylons.

2. The pylon of claim 1 wherein the walls are conical and the top plate is a circular ring.

3. The pylon of claim 2 wherein the base is provided by a base ring with a substantially flat bottom surface.

4. The pylon of claim 1 wherein the walls and top plate are made from a substantially rigid material.

5. The pylon of claim 1 wherein the walls are made from a resilient material such that same can deform in response to a force exerted thereon, and wherein the top plate includes a rigid ring defining the engagement hole.

6. A pylon handling system comprising:
a plurality of pylons according to claim 1;
a pylon handling apparatus comprising:
a hollow shaft with a handle at an upper end thereof;
a pylon engagement mechanism at an opposite lower end of the hollow shaft;
a trigger adjacent to the handle and connected through the hollow shaft to the engagement mechanism;
wherein the pylon handling apparatus is configured such that an operator holding the handle can insert the pylon engagement mechanism through the engagement hole in a first pylon past the rigid rim thereof to engage the first pylon on the pylon handling apparatus, and such that an operator holding the handle can then insert the pylon engagement mechanism through the engagement hole in a second pylon past the rigid rim thereof to engage the second pylon on the pylon handling apparatus under the first pylon; and
wherein the operator can manipulate the trigger to release the second pylon from the pylon engagement mechanism while retaining the first pylon on the pylon handling apparatus.

7. The system of claim 6 wherein the pylon handling apparatus is configured such that, with the first and second pylons engaged on the pylon handling apparatus, the operator holding the handle can insert the pylon engagement mechanism through the engagement hole in a third pylon past the rigid rim thereof to engage the third pylon on the pylon handling apparatus under the second pylon; and
wherein the operator can manipulate the trigger to release the third pylon from the pylon engagement mechanism while retaining the first and second pylons on the pylon handling apparatus.

8. The system of claim 6 wherein the pylon engagement mechanism comprises a pair of opposing pivot arms, each pivot arm comprising upper and lower lugs on outer ends thereof, the upper and lower lugs defining a recess between them configured to engage the rigid rim of a pylon, and wherein the pivot arms are mounted such that the recesses engage opposed portions of the rigid rim.

9. The system of claim 8 wherein:
the pivot arms are pivotally mounted at inner ends thereof to at least one trigger plate;
a bias force is exerted downward on the pivot arms such that the pivot arms are forced against corresponding stops fixed to the shaft; and
the at least one trigger plate is connected to the trigger such that operating the trigger raises the inner ends of the pivot arms such that the pivot arms pivot about the stops and such that the recess tilts downward.

10. The system of claim 9 wherein the pivot arms are configured such that when the pylon engagement mechanism is inserted through the engagement hole in the second pylon the lower lugs on the pivot arms contact the rigid rim of the second pylon and the pivot arms pivot upward and inward against the bias force until the lower lugs are below the rigid rim, and when the lower lugs are below the rigid rim the pivot arms move down against the stops in response to the bias force such that the rigid rim of the second pylon is positioned in the recesses of the pivot arms, and such that the upper lugs are located in the separation space between the first and second pylons.

11. The system of claim 10 wherein operating the trigger raises the inner ends of the pivot arms such that the pivot arms pivot about the stops and such that the recess tilts downward and the lower lugs move downward and inward to a location inside the engagement hole of the second pylon such that the second pylon can drop off the pylon engagement mechanism, and such that the upper lugs move outward under the rigid rim of the first pylon to prevent downward movement of the first pylon, and such that the upper lugs move downward to exert a downward force on the rigid rim of the second pylon while retaining the first pylon on the pylon engagement mechanism.

12. The system of claim 11 wherein releasing the trigger allows the inner ends of the pivot arms to move down in response to the bias force such that the recess tilts upward and the upper lugs move inward to a location inside the engagement hole of the first pylon such that the rigid rim of the first pylon can move into engagement with the recesses.

13. A pylon handling system comprising:
a plurality of pylons each pylon comprising:
a top plate defining a substantially horizontally oriented engagement hole with a substantially rigid rim; and
walls sloping outward and downward from outer edges of the top plate to a base;
wherein the pylons are configured such that a plurality of pylons can be stacked with a lower pylon nested inside an adjacent upper pylon and such that a separation space is present between the rigid rims of the upper and lower pylons;
a pylon handling apparatus comprising:
a hollow shaft with a handle at an upper end thereof;
a pylon engagement mechanism at an opposite lower end of the hollow shaft;
a trigger adjacent to the handle and connected through the hollow shaft to the engagement mechanism;
wherein the pylon handling apparatus is configured such that an operator holding the handle can insert the pylon engagement mechanism through the engagement hole in a first pylon past the rigid rim thereof to engage the first pylon on the pylon handling apparatus, and such that an operator holding the handle can then insert the pylon engagement mechanism through the engagement hole in a second pylon past the rigid rim thereof to engage the second pylon on the pylon handling apparatus under the first pylon; and
wherein the operator can manipulate the trigger to release the second pylon from the pylon engagement mechanism while retaining the first pylon on the pylon handling apparatus.

14. The system of claim 13 wherein at least one pylon comprises a plurality of spacer bumps extending inward from inner surfaces of the walls of the at least one pylon.

15. The system of claim 14 wherein the pylon handling apparatus is configured such that, with the first and second pylons engaged on the pylon handling apparatus, the operator holding the handle can insert the pylon engagement mechanism through the engagement hole in a third pylon past the rigid rim thereof to engage the third pylon on the pylon handling apparatus under the second pylon; and wherein the operator can manipulate the trigger to release the third pylon from the pylon engagement mechanism while retaining the first and second pylons on the pylon handling apparatus.

16. The system of claim 13 wherein the pylon engagement mechanism comprises a pair of opposing pivot arms, each pivot arm comprising upper and lower lugs on outer ends thereof, the upper and lower lugs defining a recess between them configured to engage the rigid rim of a pylon, and wherein the pivot arms are mounted such that the recesses engage opposed portions of the rigid rim.

17. The system of claim 16 wherein:
the pivot arms are pivotally mounted at inner ends thereof to at least one trigger plate;
a bias force is exerted downward on the pivot arms such that the pivot arms are forced against corresponding stops fixed to the shaft; and
the at least one trigger plate is connected to the trigger such that operating the trigger raises the inner ends of the pivot arms such that the pivot arms pivot about the stops and such that the lugs and recess tilt downward.

18. The system of claim 17 wherein the pivot arms are configured such that when the pylon engagement mechanism is inserted through the engagement hole in the second pylon the lower lugs on the pivot arms contact the rigid rim of the second pylon and the pivot arms pivot upward and inward against the bias force until the lower lugs are below the rigid rim, and when the lower lugs are below the rigid rim the pivot arms move down against the stops in response to the bias force such that the rigid rim of the second pylon is positioned in the recesses of the pivot arms, and such that the upper lugs are located in the separation space between the first and second pylons.

19. The system of claim 18 wherein operating the trigger raises the inner ends of the pivot arms such that the pivot arms pivot about the stops and such that the recess tilts downward and the lower lugs move downward and inward to a location inside the engagement hole of the second pylon such that the second pylon can drop off the pylon engagement mechanism, and such that the upper lugs move outward under the rigid rim of the first pylon to prevent downward movement of the first pylon, and such that the upper lugs move downward to exert a downward force on the rigid rim of the second pylon while retaining the first pylon on the pylon engagement mechanism.

20. The system of claim 19 wherein releasing the trigger allows the inner ends of the pivot arms to move down in response to the bias force such that the recess tilts upward and the upper lugs move inward to a location inside the engagement hole of the first pylon such that the rigid rim of the first pylon can move into engagement with the recesses with the lower lugs under the rigid rim of the first pylon.

21. The pylon of claim 1 wherein the base is provided by a base ring with a substantially flat bottom surface.

22. The system of claim 13 wherein the pylon handling apparatus is configured such that, with the first and second pylons engaged on the pylon handling apparatus, the operator holding the handle can insert the pylon engagement mechanism through the engagement hole in a third pylon past the rigid rim thereof to engage the third pylon on the pylon handling apparatus under the second pylon; and
wherein the operator can manipulate the trigger to release the third pylon from the pylon engagement mechanism while retaining the first and second pylons on the pylon handling apparatus.
